(19) United States
(12) Patent Application Publication
(10) Pub. No.: US 2022/0258730 A1
(43) Pub. Date: Aug. 18, 2022

(54) VEHICLE COLLISION-AVOIDANCE ASSIST DEVICE

(71) Applicant: TOYOTA JIDOSHA KABUSHIKI KAISHA, Toyota-shi (JP)

(72) Inventors: Kohei MOROTOMI, Nagoya-shi (JP); Tsunekazu YASOSHIMA, Nagoya-shi (JP); Sho HASHIMOTO, Shizuoka-ken (JP); Yumi SHIMANAKA, Kasugai-shi (JP)

(21) Appl. No.: 17/648,024

(22) Filed: Jan. 14, 2022

(30) Foreign Application Priority Data
Feb. 17, 2021 (JP) 2021-023272

(51) Int. Cl. B60W 30/09; B60W 30/095; B60W 10/20

(52) U.S. Cl. CPC B60W 30/09; B60W 30/0956; B60W 2720/24; B60W 10/20; B60W 2554/80; B60W 30/0953

(57) ABSTRACT

When a host vehicle is likely to collide with an object ahead, a vehicle collision-avoidance assist device sets a target avoidance path by which the collision is avoidable, and executes avoidance steering of forcibly steering the host vehicle so as to travel along the target avoidance path upon an avoidance steering starting condition being met. When another vehicle traveling next to the host vehicle is a vehicle traveling alongside, the device stores a vehicle-traveling-alongside travel region, and when the other vehicle is an oncoming vehicle, the device stores an oncoming vehicle travel region, and acquires a travel region of the host vehicle along the target avoidance path as an avoidance travel region. The device does not execute the avoidance steering when the avoidance travel region overlaps with the oncoming vehicle travel region, but executes the avoidance steering when the avoidance travel region overlaps with the vehicle-traveling-alongside travel region.

### CROSS-REFERENCE TO RELATED APPLICATION

This application claims priority to Japanese Patent Application No. 2021-023272 filed on Feb. 17, 2021, incorporated herein by reference in its entirety.

### BACKGROUND

### 1. Technical Field

The present disclosure relates to a vehicle collision-avoidance assist device.

### 2. Description of Related Art

There is a known vehicle collision-avoidance assist device that, when a host vehicle is likely to collide with an object present ahead of the host vehicle, executes forcible braking of forcibly braking and stopping the host vehicle and thereby preventing the host vehicle from colliding with the object. There is another known vehicle collision-avoidance assist device that, when it is expected that forcibly braking a host vehicle cannot prevent the host vehicle from colliding with an object, executes avoidance steering of forcibly steering the host vehicle so as to travel while avoiding the object and thereby preventing the host vehicle from colliding with the object (e.g., see Japanese Unexamined Patent Application Publication No. 2017-43262 (JP 2017-43262 A)).

### SUMMARY

To avoid collision between the host vehicle and the object by the avoidance steering, this conventional vehicle collision-avoidance assist device sets a path (target avoidance path) along which the host vehicle travels so as to avoid collision with the object, and this target avoidance path is a path along which the host vehicle travels inside its travel lane (own lane). The conventional vehicle collision-avoidance assist device executes the avoidance steering when such a target avoidance path can be set, but does not execute the avoidance steering when such a target avoidance path cannot be set. Therefore, when marking lines that define the own lane have not been recognized and the own lane has not been specified, the target avoidance path cannot be set and consequently the avoidance steering is not executed. Thus, when the own lane has not been specified, the driver of the host vehicle cannot receive assistance in avoiding collision between the host vehicle and the object by the avoidance steering.

An object of the present disclosure is to provide a vehicle collision-avoidance assist device that can safely avoid collision between a host vehicle and an object even when the own lane has not been specified.

A vehicle collision-avoidance assist device according to the present disclosure is configured such that, when a host vehicle is likely to collide with an object present ahead of the host vehicle, the device sets an avoidance path by which collision between the host vehicle and the object is avoidable as a target avoidance path upon an avoidance path setting condition being met, and executes avoidance steering of forcibly steering the host vehicle so as to travel along the target avoidance path upon an avoidance steering starting condition for starting the avoidance steering being met.

The vehicle collision-avoidance assist device according to the present disclosure is configured such that, when another vehicle that is traveling next to the host vehicle is a vehicle traveling alongside, the device stores a travel region that the vehicle traveling alongside occupies while traveling as a vehicle-traveling-alongside travel region; and that, when the other vehicle is an oncoming vehicle, the device stores a travel region that the oncoming vehicle occupies while traveling as an oncoming vehicle travel region. Further, the vehicle collision-avoidance assist device according to the present disclosure acquires a travel region that the host vehicle occupies when the host vehicle is assumed to travel along the target avoidance path as an avoidance travel region. When the avoidance travel region overlaps with the oncoming vehicle travel region, the device does not execute the avoidance steering even when the avoidance steering starting condition is met, and when the avoidance travel region overlaps with the vehicle-traveling-alongside travel region, the device executes the avoidance steering upon the avoidance steering starting condition being met.

When the lane next to the own lane (adjacent lane) is a lane traveling in the same direction, compared with when the adjacent lane is a lane traveling in the opposite direction, it is relatively safe for the host vehicle to enter the adjacent lane in order to avoid collision with the object. Therefore, when the avoidance travel region overlaps with the vehicle-traveling-alongside travel region, since the adjacent lane that the host vehicle is going to enter to avoid collision with the object is a lane traveling in the same direction, it is relatively safe for the host vehicle to enter that adjacent lane. According to the present disclosure, the vehicle collision-avoidance assist device does not execute the avoidance steering when the avoidance travel region overlaps with the oncoming vehicle travel region, but executes the avoidance steering when the avoidance travel region overlaps with the vehicle-traveling-alongside travel region. Accordingly, this device executes the avoidance steering even in a scene where it cannot make the host vehicle travel inside its own lane when avoiding collision between the host vehicle and the object by the avoidance steering. Thus, collision between the host vehicle and the object can be safely avoided even when the own lane has not been specified.

The vehicle collision-avoidance assist device according to the present disclosure may be configured to acquire the avoidance travel region when a lane in which the host vehicle is traveling has not been specified at the point when the avoidance path setting condition is met.

When the avoidance steering can be executed so as to make the host vehicle travel inside its own lane, it is not necessary to determine whether the avoidance travel region overlaps with the oncoming vehicle travel region or the vehicle-traveling-alongside travel region. In other words, it is necessary to acquire the avoidance travel region in a scene where the own lane cannot be specified. According to the present disclosure, the vehicle collision-avoidance assist device acquires the avoidance travel region when it cannot specify the own lane at the point when the avoidance path setting condition is met. Thus, this device can avoid unnecessarily acquiring the avoidance travel region.

The vehicle collision-avoidance assist device according to the present disclosure may be configured such that, when a lane in which the host vehicle is traveling has been specified at the point when the avoidance path setting condition is met, the device sets, as the target avoidance path, an avoidance path by which collision between the host vehicle and the object is avoidable inside the lane in which the host vehicle is traveling.

When the own lane can be specified, it is safer to execute the avoidance steering so as to make the host vehicle travel inside its own lane. According to the present disclosure, when the own lane has been specified at the point when the avoidance path setting condition is met, a target avoidance path along which the host vehicle travels inside its own lane is set. Thus, collision between the host vehicle and the object can be avoided more safely.

The vehicle collision-avoidance assist device according to the present disclosure may include a surroundings information acquisition device that acquires information on the surroundings of the host vehicle. In this case, the vehicle collision-avoidance assist device according to the present disclosure may be configured such that, when the vehicle traveling alongside is detected based on the information on the surroundings, the vehicle collision-avoidance assist device stores relative positions of the vehicle traveling alongside relative to the host vehicle at different times of day, and, based on distances that the host vehicle has traveled since the respective relative positions have been stored, converts these relative positions into positions on a travel road at which the vehicle traveling alongside was located when the respective relative positions were stored, and then acquires a travel track of the vehicle traveling alongside from these converted positions and acquires the vehicle-traveling-alongside travel region from the acquired travel track. Further, the vehicle collision-avoidance assist device according to the present disclosure may be configured such that, when the oncoming vehicle is detected based on the information on the surroundings, the vehicle collision-avoidance assist device stores relative positions of the oncoming vehicle relative to the host vehicle at different times of day, and, based on distances that the host vehicle has traveled since the respective relative positions have been stored, converts these relative positions into positions on a travel road at which the oncoming vehicle was located when the respective relative positions were stored, and then acquires a travel track of the oncoming vehicle from these converted positions and acquires the oncoming vehicle travel region from the acquired travel track.

When the host vehicle moves (travels), the position (relative position) of the vehicle traveling alongside relative to the host vehicle moves from the position on the travel road at which the vehicle traveling alongside was located at the point when that relative position was stored. However, when acquiring the vehicle-traveling-alongside travel region, it can be acquired more correctly by using the position of the vehicle traveling alongside on the travel road than using the relative position of the vehicle traveling alongside relative to the host vehicle. The same applies also to acquisition of the oncoming vehicle travel region. According to the present disclosure, based on the distances that the host vehicle has traveled since the respective relative positions of the vehicle traveling alongside relative to the host vehicle have been stored, the vehicle collision-avoidance assist device converts these relative positions into positions on the travel road at which the vehicle traveling alongside was located when the respective relative positions were stored, and acquires the vehicle-traveling-alongside travel region using these converted positions. Further, based on the distances that the host vehicle has traveled since the respective relative positions of the oncoming vehicle relative to the host vehicle have been stored, this device converts these relative positions into positions on the travel road at which the oncoming vehicle was located when the respective relative positions were stored, and acquires the oncoming vehicle travel region using these converted positions. Thus, the vehicle-traveling-alongside travel region and the oncoming vehicle travel region can be acquired more correctly.

The avoidance path setting condition is met, for example, when the distance between the host vehicle and the object becomes equal to or shorter than a predetermined distance.

The distance between the host vehicle and the object is useful as an index of the likelihood of the host vehicle colliding with the object. According to the present disclosure, the avoidance path setting condition is met when the distance between the host vehicle and the object becomes short (equal to or shorter than a predetermined distance) and the likelihood of the host vehicle colliding with the object becomes high. When the avoidance path setting condition is met, the target avoidance path is set. Thus, the target avoidance path can be set before the likelihood of the host vehicle colliding with the object becomes extremely high.

The avoidance steering starting condition is met, for example, when the time expected to be taken for the host vehicle to reach the object becomes equal to or shorter than a predetermined time.

If the likelihood of the host vehicle colliding with the object cannot be correctly determined, the avoidance steering is executed in vain. The likelihood of the host vehicle colliding with the object can be determined more correctly by using the time expected to be taken for the host vehicle to reach the object. According to the present disclosure, the avoidance steering starting condition is met and the avoidance steering is executed when the time expected to be taken for the host vehicle to reach the object becomes short (equal to or shorter than a predetermined time). Thus, the avoidance steering can be prevented from being executed in vain.

The target avoidance path may be set by taking into account a relative speed of the host vehicle relative to the object at the point when the avoidance path setting condition is met.

The target avoidance path for avoiding collision between the host vehicle and the object is different between when the relative speed of the host vehicle relative to the object is high and when the relative speed is low. According to the present disclosure, the target avoidance path is set by taking into account the relative speed of the host vehicle relative to the object. Thus, a target avoidance path can be set by which collision between the host vehicle and the object can be avoided more reliably.

The constituent elements of the present disclosure are not limited to those in an embodiment of the present disclosure to be described below with reference to the drawings. Other objects, other features, and accompanying advantages of the present disclosure will be easily understood from the description of the embodiment of the present disclosure.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a vehicle collision-avoidance assist device according to an embodiment of the present disclosure and a vehicle (host vehicle) equipped with this vehicle collision-avoidance assist device;

FIG. 2A is a view showing marking lines that define a travel lane of the host vehicle (own lane);

FIG. 2B is a view showing a yaw angle of the host vehicle;

FIG. 2C is a view showing a yaw angle of the host vehicle;

FIG. 3 is a view showing a host vehicle travel region;

FIG. 4A is a view showing another vehicle (vehicle traveling alongside) that is traveling next to the host vehicle on a right side, in the same direction as a travel direction of the host vehicle at first time of day;

FIG. 4B is a view showing the vehicle traveling alongside that is traveling next to the host vehicle on the right side, in the same direction as the travel direction of the host vehicle at second time of day after the first time of day;

FIG. 4C is a view showing the vehicle traveling alongside that is traveling next to the host vehicle on the right side, in the same direction as the travel direction of the host vehicle at third time of day after the second time of day;

FIG. 4D is a view showing the vehicle traveling alongside that is traveling next to the host vehicle on the right side, in the same direction as the travel direction of the host vehicle at fourth time of day after the third time of day;

FIG. 5A is a view showing the position of the vehicle traveling alongside at the first time of day;

FIG. 5B is a view showing the position of the vehicle traveling alongside at the second time of day after the first time of day;

FIG. 5C is a view showing the position of the vehicle traveling alongside at the third time of day after the second time of day;

FIG. 5D is a view showing the position of the vehicle traveling alongside at the fourth time of day after the third time of day;

FIG. 6A is a view showing the positions of the vehicle traveling alongside at the respective first time of day to fourth time of day;

FIG. 6B is a view showing a travel region of the vehicle traveling alongside that is inferred from these positions of the vehicle traveling alongside (vehicle-traveling-alongside travel history region);

FIG. 6C is a view showing a vehicle-traveling-alongside travel region that is set from the vehicle-traveling-alongside travel history region;

FIG. 7A is a view showing another vehicle (oncoming vehicle) that is traveling next to the host vehicle on the right side, in the direction opposite from the travel direction of the host vehicle at first time of day;

FIG. 7B is a view showing the oncoming vehicle that is traveling next to the host vehicle on the right side, in the direction opposite from the travel direction of the host vehicle at second time of day after the first time of day;

FIG. 7C is a view showing the oncoming vehicle that is traveling next to the host vehicle on the right side, in the direction opposite from the travel direction of the host vehicle at third time of day after the second time of day;

FIG. 7D is a view showing the oncoming vehicle that is traveling next to the host vehicle on the right side, in the direction opposite from the travel direction of the host vehicle at fourth time of day after the third time of day;

FIG. 8A is a view showing the position of the oncoming vehicle at the first time of day;

FIG. 8B is a view showing the position of the oncoming vehicle at the second time of day after the first time of day;

FIG. 8C is a view showing the position of the oncoming vehicle at the third time of day after the second time of day;

FIG. 8D is a view showing the position of the oncoming vehicle at the fourth time of day after the third time of day;

FIG. 9A is a view showing the positions of the oncoming vehicle at the respective first time of day to fourth time of day;

FIG. 9B is a view showing a travel region of the oncoming vehicle that is inferred from the positions of the oncoming vehicle at the respective first time of day to fourth time of day (oncoming vehicle travel history region);

FIG. 9C is a view showing an oncoming vehicle travel region that is set from the oncoming vehicle travel history region;

FIG. 10A is a view showing a scene where there is an object (vehicle) in a host vehicle travel region in a situation where the left and right marking lines defining the own lane have been recognized;

FIG. 10B is a view showing a scene where there is an object (vehicle) in the host vehicle travel region in a situation where the left and right marking lines defining the own lane have not been recognized;

FIG. 11 is a view showing a target avoidance path that is set when the left and right marking lines defining the own lane have been recognized;

FIG. 12A is a view showing a target avoidance path that is set when the left and right marking lines defining the own lane have not been recognized;

FIG. 12B is a view showing a target avoidance path that can be set when the left and right marking lines defining the own lane have not been recognized;

FIG. 12C is a view showing an avoidance travel region;

FIG. 13A is a view showing a scene where the avoidance travel region overlaps with the vehicle-traveling-alongside travel region;

FIG. 13B is a view showing a scene where the avoidance travel region does not overlap with the vehicle-traveling-alongside travel region;

FIG. 13C is a view showing a scene where the avoidance travel region overlaps with the oncoming vehicle travel region;

FIG. 13D is a view showing a scene where the avoidance travel region does not overlap with the oncoming vehicle travel region;

FIG. 14A is a view showing a scene where avoidance steering is started in a situation where the left and right marking lines defining the own lane have been recognized;

FIG. 14B is a view showing a scene where the host vehicle is traveling while avoiding an object by the avoidance steering;

FIG. 14C is a view showing a scene where the avoidance steering is started in a situation where the left and right marking lines defining the own lane have not been recognized;

FIG. 14D is a view showing a scene where the host vehicle is traveling while avoiding the object by the avoidance steering;

FIG. 15A is a view showing a scene where a condition for ending the avoidance steering is met in a situation where the left and right marking lines defining the own lane have been recognized;

FIG. 15B is a view showing a scene where the condition for ending the avoidance steering is met in a situation where the left and right marking lines defining the own lane have not been recognized;

FIG. 16 is a flowchart showing a routine executed by the vehicle collision-avoidance assist device according to the embodiment of the present disclosure;

FIG. 17 is a flowchart showing a routine executed by the vehicle collision-avoidance assist device according to the embodiment of the present disclosure;

FIG. 18 is a flowchart showing a routine executed by the vehicle collision-avoidance assist device according to the embodiment of the present disclosure;

FIG. 19 is a flowchart showing a routine executed by the vehicle collision-avoidance assist device according to the embodiment of the present disclosure;

FIG. 20 is a flowchart showing a routine executed by a vehicle collision-avoidance assist device according to a modified example of the embodiment of the present disclosure; and

FIG. 21 is a flowchart showing a routine executed by the vehicle collision-avoidance assist device according to the modified example of the embodiment of the present disclosure.

### DETAILED DESCRIPTION OF EMBODIMENTS

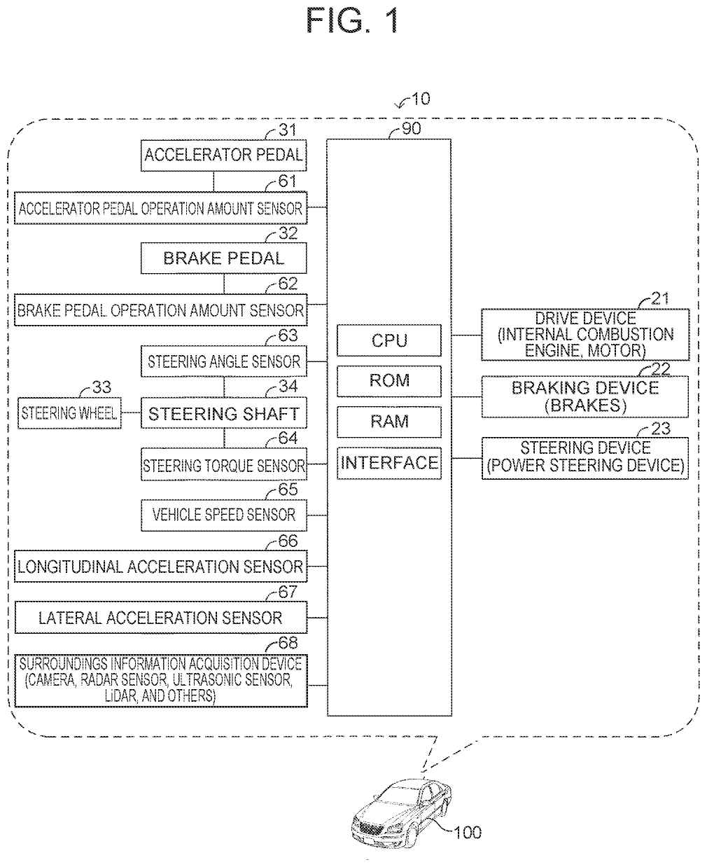

A vehicle collision-avoidance assist device according to an embodiment of the present disclosure will be described below with reference to the drawings. As shown in FIG. 1, a vehicle collision-avoidance assist device 10 according to the embodiment of the present disclosure is mounted in a host vehicle 100.

ECU

As shown in FIG. 1, the vehicle collision-avoidance assist device 10 includes an ECU 90. “ECU” stands for “electronic control unit.” The ECU 90 includes a microcomputer as a main component. The microcomputer includes a CPU, an ROM, an RAM, a non-volatile memory, an interface, and others. The CPU realizes various functions by executing instructions, programs, or routines stored in the ROM.

Drive Device and Others

The host vehicle 100 is equipped with a drive device 21, a braking device 22, and a steering device 23.

Drive Device

The drive device 21 is a device that outputs drive power to be provided to the host vehicle 100 to enable the host vehicle 100 to travel, and is, for example, an internal combustion engine and a motor. The drive device 21 is electrically connected to the ECU 90. The ECU 90 can control the drive power output from the drive device 21 by controlling the operation of the drive device 21.

Braking Device

The braking device 22 is a device that outputs braking power to be provided to the host vehicle 100 to brake the host vehicle 100, and is, for example, brakes. The braking device 22 is electrically connected to the ECU 90. The ECU 90 can control the braking power output from the braking device 22 by controlling the operation of the braking device 22.

Steering Device

The steering device 23 is a device that outputs steering power to be provided to the host vehicle 100 to steer the host vehicle 100, and is, for example, a power steering device. The steering device 23 is electrically connected to the ECU 90. The ECU 90 can control the steering power output from the steering device 23 by controlling the operation of the steering device 23.

Sensors and Others

The host vehicle 100 is further equipped with an accelerator pedal operation amount sensor 61, a brake pedal operation amount sensor 62, a steering angle sensor 63, a steering torque sensor 64, a vehicle speed sensor 65, a longitudinal acceleration sensor 66, a lateral acceleration sensor 67, and a surroundings information acquisition device 68.

Accelerator Pedal Operation Amount Sensor

The accelerator pedal operation amount sensor 61 is electrically connected to the ECU 90. The accelerator pedal operation amount sensor 61 detects an operation amount of an accelerator pedal 31 and sends information on the detected operation amount to the ECU 90. Based on this information, the ECU 90 acquires the operation amount of the accelerator pedal 31 as an accelerator pedal operation amount AP. The ECU 90 acquires required drive power PDreq from the accelerator pedal operation amount AP and a vehicle speed V of the host vehicle 100 by calculation. The required drive power PDreq is drive power that the drive device 21 is required to output.

Brake Pedal Operation Amount Sensor

The brake pedal operation amount sensor 62 is electrically connected to the ECU 90. The brake pedal operation amount sensor 62 detects an operation amount of a brake pedal 32 and sends information on the detected operation amount to the ECU 90. Based on this information, the ECU 90 acquires the operation amount of the brake pedal 32 as a brake pedal operation amount BP. The ECU 90 acquires required braking power PBreq from the brake pedal operation amount BP by calculation. The required braking power PBreq is braking power that the braking device 22 is required to output.

Steering Angle Sensor

The steering angle sensor 63 is electrically connected to the ECU 90. The steering angle sensor 63 detects a rotation angle of a steering wheel 33 of the host vehicle 100 relative to a neutral position of the steering wheel 33 and sends information on the detected rotation angle to the ECU 90. Based on this information, the ECU 90 acquires the rotation angle of the steering wheel 33 of the host vehicle 100 relative to the neutral position as a steering angle SA.

Steering Torque Sensor

The steering torque sensor 64 is electrically connected to the ECU 90. The steering torque sensor 64 detects a torque that the driver inputs into a steering shaft 34 through the steering wheel 33 and sends information on the detected torque to the ECU 90. Based on this information, the ECU 90 acquires the torque that the driver inputs into the steering shaft 34 through the steering wheel 33 as a driver-input torque TQdr.

Vehicle Speed Sensor

The vehicle speed sensor 65 is electrically connected to the ECU 90. The vehicle speed sensor 65 detects a rotation speed of each wheel of the host vehicle 100 and sends information on the detected rotation speed of each wheel to the ECU 90. Based on this information, the ECU 90 acquires the travel speed of the host vehicle 100 as the vehicle speed V.

The ECU 90 further acquires a torque to be applied from the steering device 23 to the steering shaft 34 (assisting steering torque TQas) by calculation based on the acquired steering angle SA, driver-input torque TQdr, and vehicle speed V. The assisting steering torque TQas is a torque that is applied to the steering shaft 34 to assist the driver in steering operation of the steering wheel 33.

Longitudinal Acceleration Sensor

The longitudinal acceleration sensor 66 is electrically connected to the ECU 90. The longitudinal acceleration sensor 66 detects acceleration of the host vehicle 100 in a front-rear direction and sends information on the detected acceleration to the ECU 90. Based on this information, the ECU 90 acquires the acceleration of the host vehicle 100 in the front-rear direction as a longitudinal acceleration Gx.

Lateral Acceleration Sensor

The lateral acceleration sensor 67 is electrically connected to the ECU 90. The lateral acceleration sensor 67 detects acceleration of the host vehicle 100 in a lateral direction (width direction) and sends information on the detected acceleration to the ECU 90. Based on this information, the ECU 90 acquires the acceleration of the host vehicle 100 in the lateral direction as a lateral acceleration Gy.

Surroundings Information Acquisition Device

The surroundings information acquisition device 68 is a device that detects information on the surroundings of the host vehicle 100, and includes, for example, a camera, a radar sensor (millimeter-wave radar or the like), an ultrasonic sensor (clearance sonar), and a laser radar (LiDAR).

The surroundings information acquisition device 68 is electrically connected to the ECU 90. The surroundings information acquisition device 68 detects information on the surroundings of the host vehicle 100 and sends detected information (surroundings information I_S) to the ECU 90.

Based on the surroundings information I_S (particularly information on a front side of the host vehicle 100), the ECU 90 can detect an object present ahead of the host vehicle 100. When such an object is detected, the ECU 90 can acquire the distance between the object and the host vehicle 100 (object distance D200), a relative speed dV of the host vehicle 100 relative to the object, and a moving direction of the object, based on the surroundings information I_S.

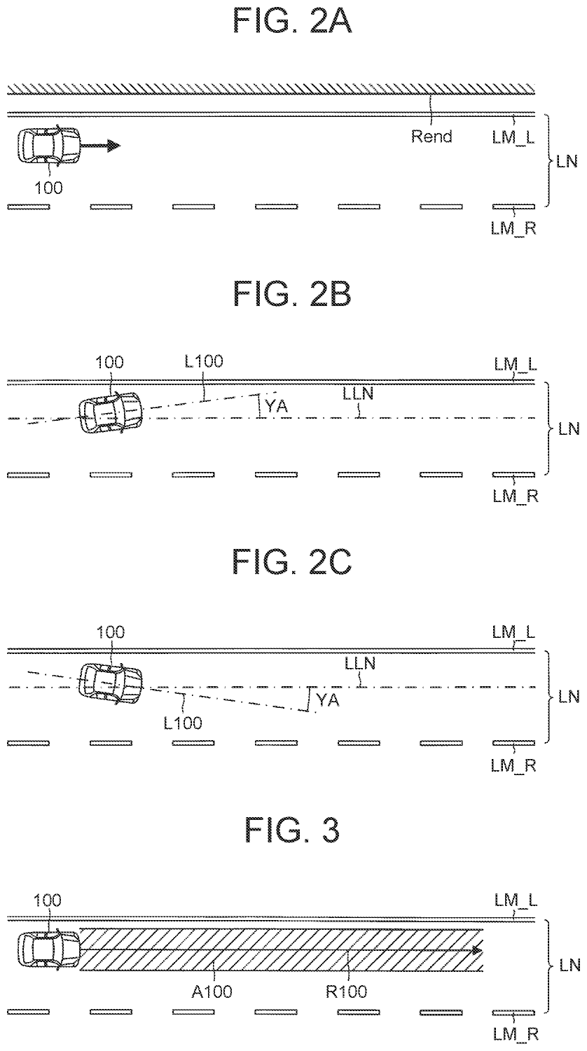

Further, as shown in FIG. 2A, based on the surroundings information I_S, the ECU 90 can recognize a left marking line LM_L and a right marking line LM_R defining a travel lane of the host vehicle 100 (own lane LN), or an end of the road on which the host vehicle 100 is traveling (so-called road end Rend).

Based on the recognized left and right marking lines LM (i.e., the left marking line LM_L and the right marking line LM_R) or the road end Rend, the ECU 90 acquires a yaw angle YA. As shown in FIG. 2B and FIG. 2C, the yaw angle YA is an angle between an own lane extension-direction line LLN (a line indicating an extension direction of the own lane LN) and a host vehicle central front-rear line L100 (a line extending in the front-rear direction of the host vehicle 100 at the center of the host vehicle 100 in the width direction).

Further, based on the recognized left and right marking lines LM, the ECU 90 can specify the range of the own lane LN.

In addition, based on the surroundings information I_S, the ECU 90 can detect other vehicles around the host vehicle 100.

Outline of Operation of Vehicle Collision-Avoidance Assist Device

Next, an outline of the operation of the vehicle collision-avoidance assist device 10 will be described. While the host vehicle 100 is traveling, the vehicle collision-avoidance assist device 10 is determining whether there is an object on a front side in an advancing direction of the host vehicle 100 based on the surroundings information I_S (particularly information on the front side of the host vehicle 100). More specifically, while the host vehicle 100 is traveling, the vehicle collision-avoidance assist device 10 is determining whether there is an object 200 in a host vehicle travel region A100 based on the surroundings information I_S. As shown in FIG. 3, the host vehicle travel region A100 is a region that is centered at a travel route R100 of the host vehicle 100 and has the same width as the width of the host vehicle 100. The travel route R100 of the host vehicle 100 is a route along which the host vehicle 100 travels if the host vehicle 100 travels while maintaining the steering angle SA at that time. In this embodiment, the object is a vehicle, a person, a bicycle, a guardrail, or the like.

When there is no object 200 on the front side in the advancing direction of the host vehicle 100, and when there is an object 200 on the front side in the advancing direction of the host vehicle 100 but the host vehicle 100 is unlikely to collide with that object, the vehicle collision-avoidance assist device 10 executes normal travel control. Under the normal travel control, when the required drive power PDreq is higher than zero, the operation of the drive device 21 is controlled such that this required drive power PDreq is output from the drive device 21, and when the required braking power PBreq is higher than zero, the operation of the braking device 22 is controlled such that this required braking power PBreq is output from the braking device 22, and when the assisting steering torque TQas is higher than zero, the operation of the steering device 23 is controlled such that this assisting steering torque TQas is output from the steering device 23.

Further, while the host vehicle 100 is traveling, the vehicle collision-avoidance assist device 10 is acquiring a vehicle-traveling-alongside travel region A201 and an oncoming vehicle travel region A202 next to the host vehicle 100 on a right side and a left side based on the surroundings information I_S. The vehicle-traveling-alongside travel region A201 is a travel region that, when the lane next to the host vehicle 100 on the right side or the left side is a lane traveling in the same direction, a vehicle traveling alongside is expected to occupy while traveling. The oncoming vehicle travel region A202 is a travel region that, when the lane next to the host vehicle 100 on the right side or the left side is a lane traveling in the opposite direction, an oncoming vehicle is expected to occupy while traveling.

Acquisition of Vehicle-Traveling-Alongside Travel Region

The vehicle collision-avoidance assist device 10 acquires the vehicle-traveling-alongside travel region A201 as follows.

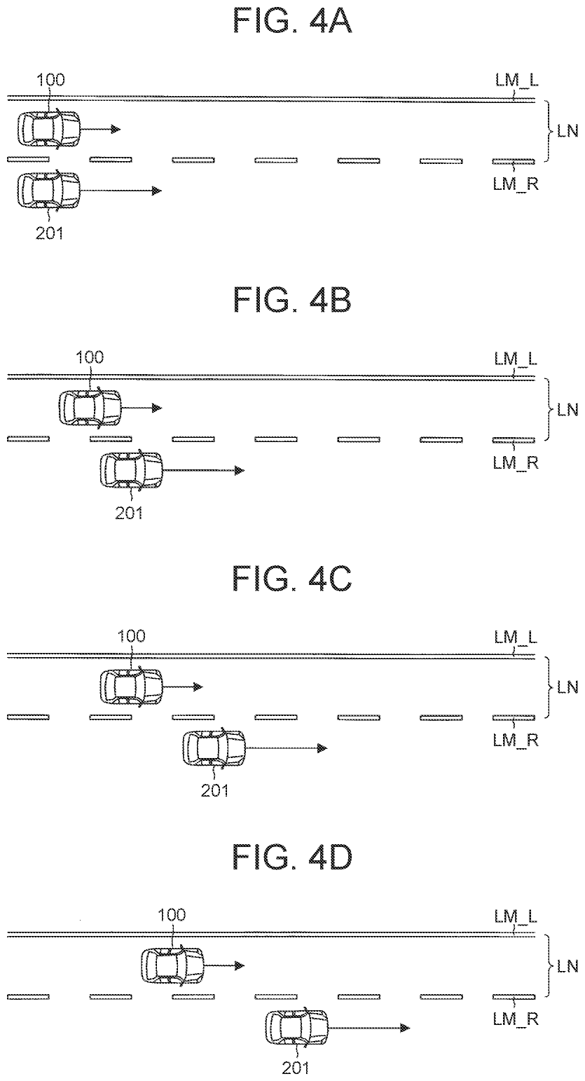

It is assumed that, when the next lane on the right side of the host vehicle 100 is a lane traveling in the same direction, a vehicle-traveling-alongside 201 travels as shown in FIG. 4A to FIG. 4D. Specifically, it is assumed that the vehicle-traveling-alongside 201 that is located at the position shown in FIG. 4A at first time of day t1 travels to the position shown in FIG. 4B during the period from the first time of day t1 to second time of day t2, and then travels to the position shown in FIG. 4C during the period up to third time of day t3, and then travels to the position shown in FIG. 4D during the period up to fourth time of day t4.

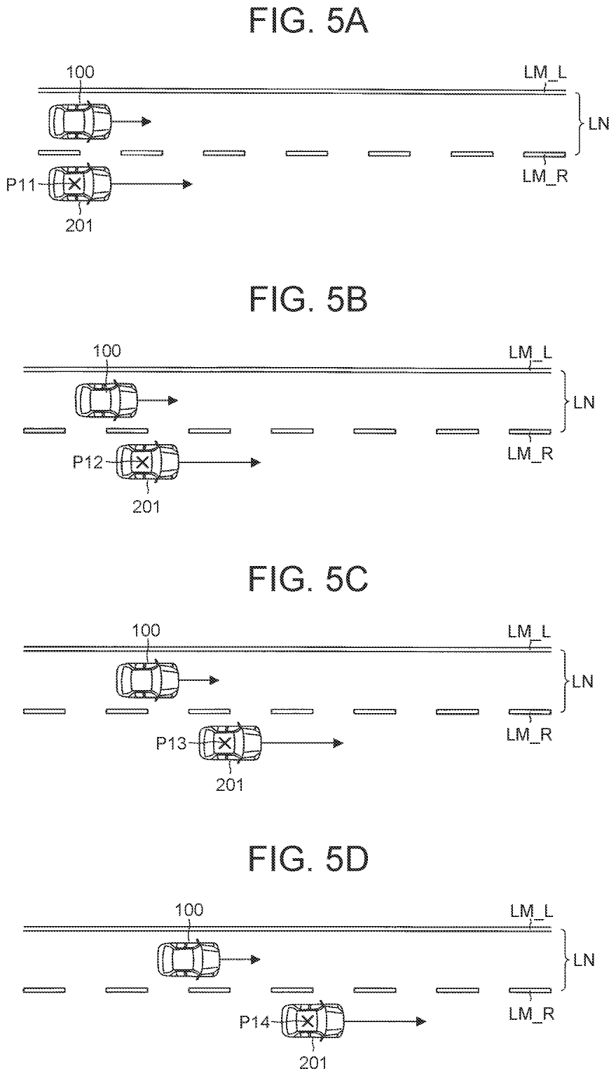

In this case, the position of the vehicle-traveling-alongside 201 (vehicle-traveling-alongside position P1) inferred from the surroundings information I_S moves as shown in FIG. 5A to FIG. 5D. Specifically, a vehicle-traveling-alongside position P11 at the first time of day t1 is located at the position shown in FIG. 5A. A vehicle-traveling-alongside position P12 at the second time of day t2 is located at the position shown in FIG. 5B. A vehicle-traveling-alongside position P13 at the third time of day t3 is located at the position shown in FIG. 5C. A vehicle-traveling-alongside position P14 at the fourth time of day t4 is located at the position shown in FIG. 5D.

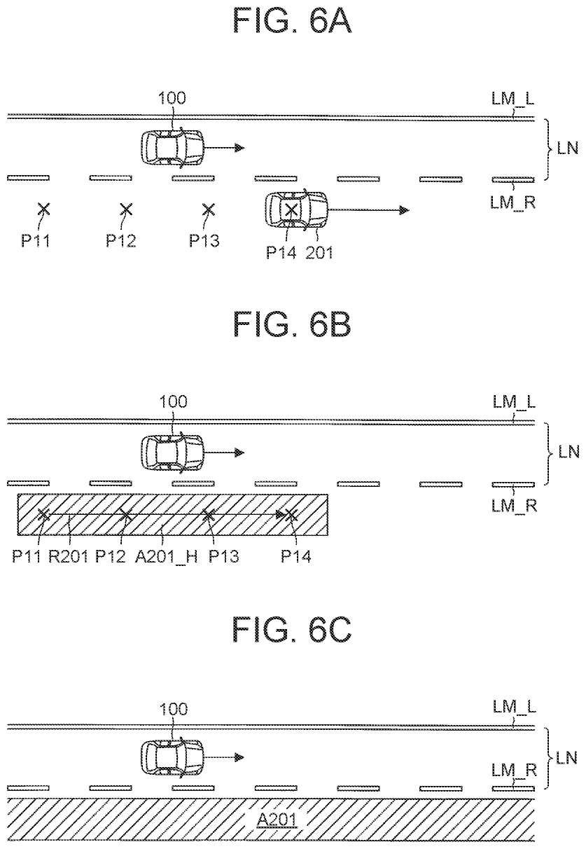

Therefore, the vehicle-traveling-alongside position P11 to the vehicle-traveling-alongside position P14 at the respective first time of day t1 to fourth time of day t4 move as shown in FIG. 6A. FIG. 6A shows states of the host vehicle 100 and the vehicle-traveling-alongside 201 at the fourth time of day t4.

Therefore, if the vehicle-traveling-alongside positions P11 to P14 at the respective first time of day t1 to fourth time of day t4 can be located, the track on which the vehicle-traveling-alongside 201 has actually traveled (vehicle-traveling-alongside travel track R201) can be acquired from these vehicle-traveling-alongside positions P11 to P14.

When the vehicle-traveling-alongside 201 is detected based on the surroundings information I_S, the vehicle collision-avoidance assist device 10 can acquire the position of the vehicle-traveling-alongside 201 relative to the host vehicle 100 (relative position). This position moves as the host vehicle 100 moves, and therefore differs from the vehicle-traveling-alongside position P1 as described above (the position of the vehicle-traveling-alongside 201 on the travel road (the road on which the vehicle-traveling-alongside 201 is actually traveling)).

Therefore, when the vehicle-traveling-alongside 201 is detected based on the surroundings information I_S, the vehicle collision-avoidance assist device 10 stores the relative positions (vehicle-traveling-alongside relative positions P1_R) of the vehicle-traveling-alongside 201 relative to the host vehicle 100 at a plurality of different times of day. Then, based on the distances that the host vehicle 100 has traveled (host vehicle travel distances) since the respective vehicle-traveling-alongside relative positions P1_R have been stored, the vehicle collision-avoidance assist device 10 converts these vehicle-traveling-alongside relative positions P1_R into positions on the travel road at which the vehicle-traveling-alongside 201 was located when the respective vehicle-traveling-alongside relative positions P1_R were stored. More specifically, the vehicle collision-avoidance assist device 10 converts the vehicle-traveling-alongside relative positions P1_R into positions on the travel road at which the vehicle-traveling-alongside 201 was located at the points in time when the respective positions were stored, by moving the vehicle-traveling-alongside relative positions P1_R toward the rear side relative to the host vehicle 100 each by the distance that the host vehicle 100 has traveled since that vehicle-traveling-alongside relative position P1_R has been stored.

These converted positions correspond to the vehicle-traveling-alongside positions P1 described above. As shown in FIG. 6B, the vehicle collision-avoidance assist device 10 acquires the travel track of the vehicle-traveling-alongside 201 (vehicle-traveling-alongside travel track R201) from these converted positions, and acquires a vehicle-traveling-alongside travel history region A201_H based on the vehicle-traveling-alongside travel track R201. More specifically, the vehicle collision-avoidance assist device 10 acquires, as the vehicle-traveling-alongside travel history region A201_H, a region that is centered at the vehicle-traveling-alongside travel track R201 and has the same width as the width of the vehicle-traveling-alongside 201. In the example shown in FIG. 6A to FIG. 6C, the vehicle-traveling-alongside travel history region A201_H is a travel region that the vehicle-traveling-alongside 201 occupies when the vehicle-traveling-alongside 201 actually travels from the first time of day t1 to the fourth time of day t4.

Further, as shown in FIG. 6C, the vehicle collision-avoidance assist device 10 acquires, as the vehicle-traveling-alongside travel region A201, a region in which the vehicle-traveling-alongside 201 is expected to travel based on the acquired vehicle-traveling-alongside travel history region A201_H. In this embodiment, the vehicle collision-avoidance assist device 10 acquires, as the vehicle-traveling-alongside travel region A201, a region obtained by extending the vehicle-traveling-alongside travel history region A201_H toward the front side and the rear side in the advancing direction of the host vehicle 100.

Acquisition of Oncoming Vehicle Travel Region

The vehicle collision-avoidance assist device 10 acquires the oncoming vehicle travel region A202 as follows.

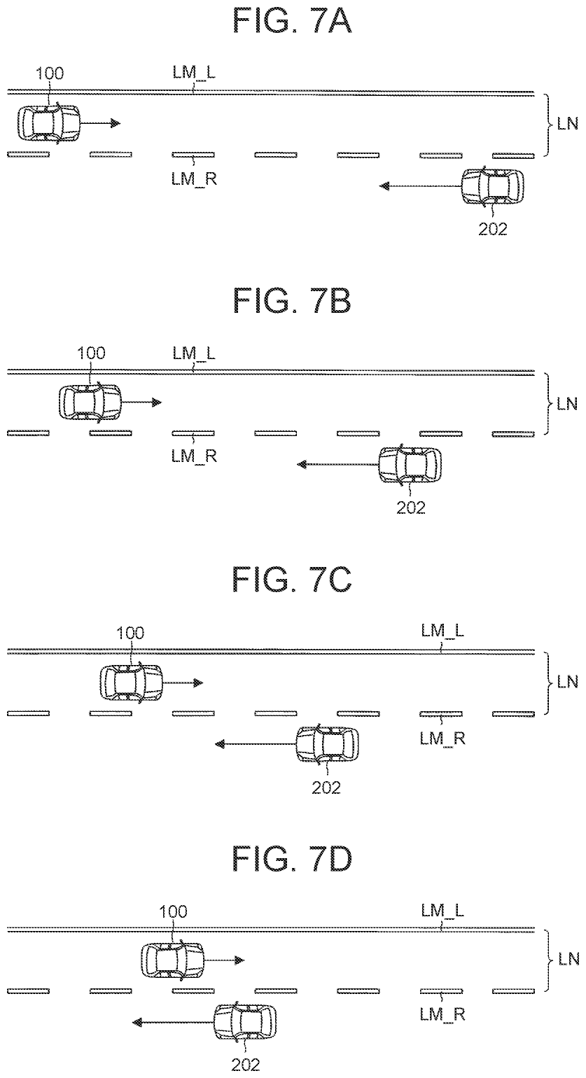

It is assumed that, when the next lane on the right side of the host vehicle 100 is a lane traveling in the opposite direction, the oncoming vehicle 202 travels as shown in FIG. 7A to FIG. 7D. Specifically, it is assumed that the oncoming vehicle 202 that is located at the position shown in FIG. 7A at first time of day t1 travels to the position shown in FIG. 7B during the period from the first time of day t1 to second time of day t2, and then travels to the position shown in FIG. 7C during the period up to third time of day t3, and then travels to the position shown in FIG. 7D during the period up to fourth time of day t4.

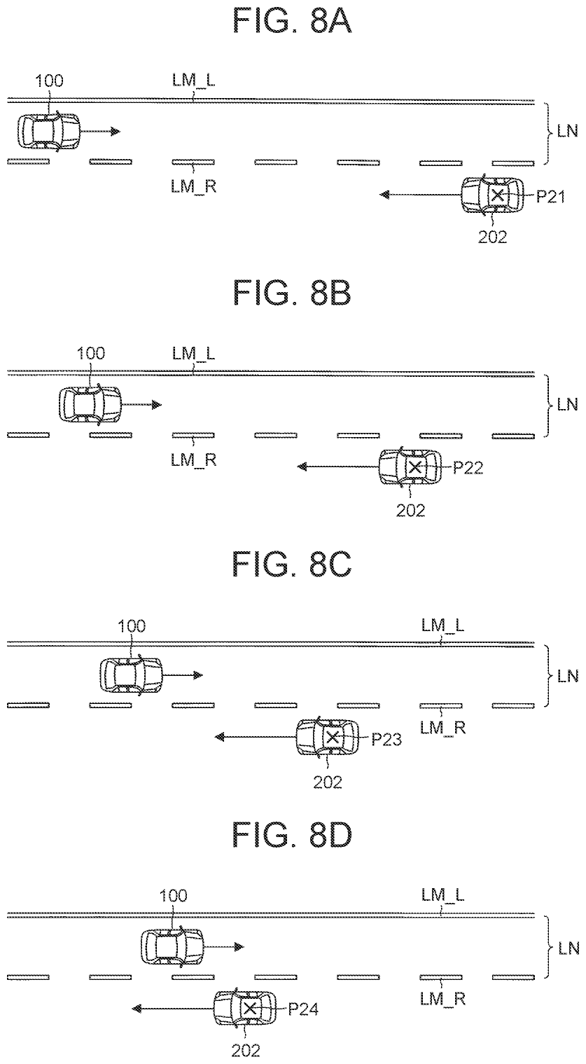

In this case, the position of the oncoming vehicle 202 (oncoming vehicle position P2) inferred from the surroundings information I_S moves as shown in FIG. 8A to FIG. 8D. Specifically, an oncoming vehicle position P21 at the first time of day t1 is located at the position shown in FIG. 8A. An oncoming vehicle position P22 at the second time of day t2 is located at the position shown in FIG. 8B. An oncoming vehicle position P23 at the third time of day t3 is located at the position shown in FIG. 8C. An oncoming vehicle position P24 at the fourth time of day t4 is located at the position shown in FIG. 8D.

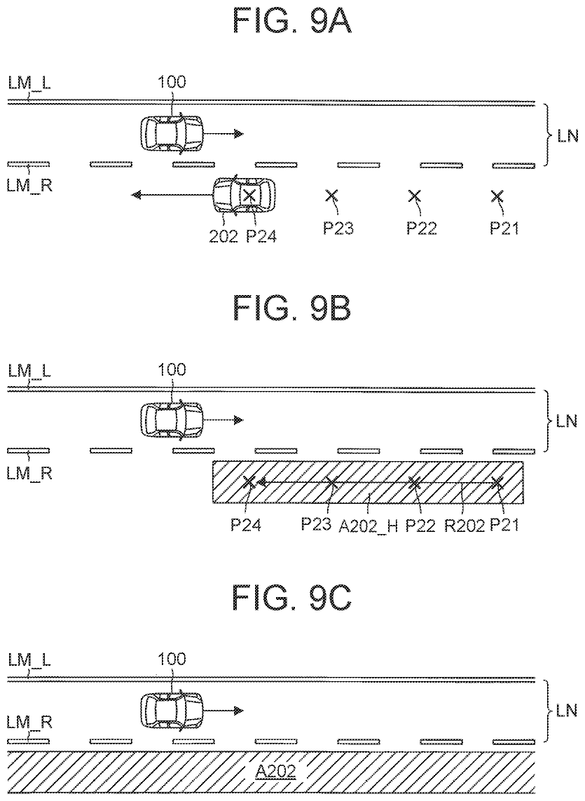

Thus, the oncoming vehicle position P21 to the oncoming vehicle position P24 at the respective first time of day t1 to fourth time of day t4 move as shown in FIG. 9A. FIG. 9A shows states of the host vehicle 100 and the oncoming vehicle 202 at the fourth time of day t4.

Therefore, when the oncoming vehicle positions P21 to P24 at the respective first time of day t1 to fourth time of day t4 can be located, the track on which the oncoming vehicle 202 has actually traveled (oncoming vehicle travel track R202) can be acquired from these oncoming vehicle positions P21 to P24.

When the oncoming vehicle 202 is detected based on the surroundings information I_S, the vehicle collision-avoidance assist device 10 can acquire the position of the oncoming vehicle 202 relative to the host vehicle 100 (relative position). This position moves as the host vehicle 100 moves, and therefore differs from the oncoming vehicle position P2 as described above (the position of the oncoming vehicle 202 on the travel road (the road on which the oncoming vehicle 202 is actually traveling)).

Therefore, when the oncoming vehicle 202 is detected based on the surroundings information I_S, the vehicle collision-avoidance assist device 10 stores the relative positions (oncoming vehicle relative positions P2_R) of the oncoming vehicle 202 relative to the host vehicle 100 at a plurality of different times of day. Then, based on the distances that the host vehicle 100 has traveled (host vehicle travel distances) since the respective oncoming vehicle relative positions P2_R have been stored, the vehicle collision-avoidance assist device 10 converts these oncoming vehicle relative positions P2_R into positions on the travel road at which the oncoming vehicle 202 was located when the respective oncoming vehicle relative positions P2_R were stored. More specifically, the vehicle collision-avoidance assist device 10 converts the oncoming vehicle relative positions P2_R into positions on the travel road at which the oncoming vehicle 202 was located at the points in time when the respective oncoming vehicle relative positions P2_R were stored, by moving the oncoming vehicle relative positions P2_R toward the rear side relative to the host vehicle 100 each by the distance that the host vehicle 100 has traveled since that oncoming vehicle relative position P2_R has been stored.

These converted positions correspond to the oncoming vehicle positions P2 described above. As shown in FIG. 9B, the vehicle collision-avoidance assist device 10 acquires the travel track of the oncoming vehicle 202 (oncoming vehicle travel track R202) from these converted positions, and acquires an oncoming vehicle travel history region A202_H based on the oncoming vehicle travel track R202. More specifically, the vehicle collision-avoidance assist device 10 acquires, as the oncoming vehicle travel history region A202_H, a region that is centered at the oncoming vehicle travel track 8202 and has the same width as the width of the oncoming vehicle 202. In the example shown in FIG. 9A to FIG. 9C, the oncoming vehicle travel history region A202_H is a travel region that the oncoming vehicle 202 occupies when the oncoming vehicle 202 actually travels from the first time of day t1 to the fourth time of day t4.

Further, as shown in FIG. 9C, the vehicle collision-avoidance assist device 10 acquires, as the oncoming vehicle travel region A202, a region in which the oncoming vehicle 202 is expected to travel based on the acquired oncoming vehicle travel history region A202_H. In this embodiment, the vehicle collision-avoidance assist device 10 acquires, as the oncoming vehicle travel region A202, a region obtained by extending the oncoming vehicle travel history region A202_H toward the front side and the rear side in the advancing direction of the host vehicle 100.

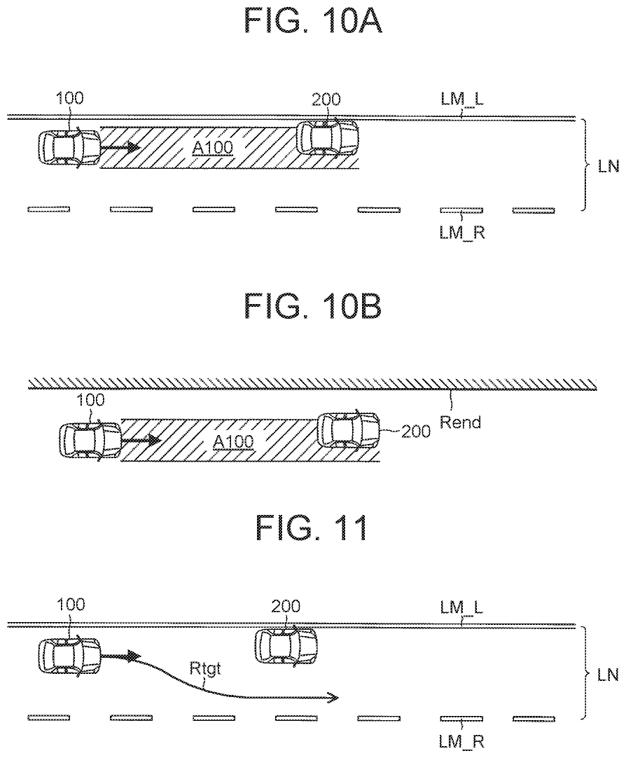

As shown in FIG. 10A and FIG. 10B, when there is an object 200 inside the host vehicle travel region A100, the vehicle collision-avoidance assist device 10 acquires the object distance D200, the relative speed dV, and an expected reaching time TTC based on the surroundings information I_S on a predetermined calculation cycle. The object distance D200 is the distance between the host vehicle 100 and the object 200 present inside the host vehicle travel region A100. The relative speed dV is the speed of the host vehicle 100 relative to the object 200 present inside the host vehicle travel region A100. The expected reaching time TTC is the time expected to be taken for the host vehicle 100 to reach the object 200. The vehicle collision-avoidance assist device 10 acquires the expected reaching time TTC by dividing the object distance D200 by the relative speed dV (=D200/dV). For as long as it is determined that there is an object 200 inside the host vehicle travel region A100, the vehicle collision-avoidance assist device 10 performs acquisition of the object distance D200, the relative speed dV, and the expected reaching time TTC on a predetermined calculation cycle CYC.

FIG. 10A shows a scene where there is an object 200 inside the host vehicle travel region A100 in a situation where the left and right marking lines LM have been recognized from the surroundings information I_S. FIG. 10B shows a scene where there is an object 200 inside the host vehicle travel region A100 in a situation where the left and right marking lines LM have not been recognized from the surroundings information I_S.

When the object distance D200 decreases to a predetermined distance (predetermined object distance D200th), the vehicle collision-avoidance assist device 10 determines that an avoidance path setting condition is met. Specifically, the vehicle collision-avoidance assist device 10 acquires the object distance D200 as an index value showing the likelihood of the host vehicle 100 colliding with the object 200, and when this index value becomes equal to or larger than a predetermined index value, determines that the avoidance path setting condition is met. In this case, therefore, the index value showing the likelihood of the host vehicle 100 colliding with the object 200 becomes larger as the object distance D200 becomes shorter.

When the vehicle collision-avoidance assist device 10 determines that the avoidance path setting condition is met, it starts a process of setting a path along which the host vehicle 100 travels so as to avoid the object 200 (target avoidance path Rtgt).

In this embodiment, when the left and right marking lines LM have been recognized from the surroundings information I_S, as shown in FIG. 11, the vehicle collision-avoidance assist device 10 sets, as the target avoidance path Rtgt, a path along which the host vehicle 100 can travel so as to avoid and pass by the object 200 while traveling inside its own lane LN (i.e., without moving out of its own lane LN). The target avoidance path Rtgt shown in FIG. 11 is a path along which the host vehicle 100 travels so as to pass on the right side of the object 200. When there is a space for the host vehicle 100 to travel through on the left side of the object 200, a target avoidance path Rtgt that passes on the left side of the object 200 may be set.

The vehicle collision-avoidance assist device 10 may be configured such that, in the case where there is a space for the host vehicle 100 to travel through on the right side of the object 200, when at least the right marking line LM_R defining the own lane LN has been recognized, the device sets, as the target avoidance path Rtgt, a path along which the host vehicle 100 can pass on the right side of the object 200 while traveling on the left side of the right marking line LM_R (i.e., without moving out to the right side of the right marking line LM_R). Similarly, the vehicle collision-avoidance assist device 10 may be configured such that, in the case where there is a space for the host vehicle 100 to travel through on the left side of the object 200, when at least the left marking line LM_L defining the own lane LN has been recognized, the device sets, as the target avoidance path Rtgt, a path along which the host vehicle 100 can pass on the left side of the object 200 while traveling on the right side of the left marking line LM_L (i.e., without moving out to the left side of the left marking line LM_L).

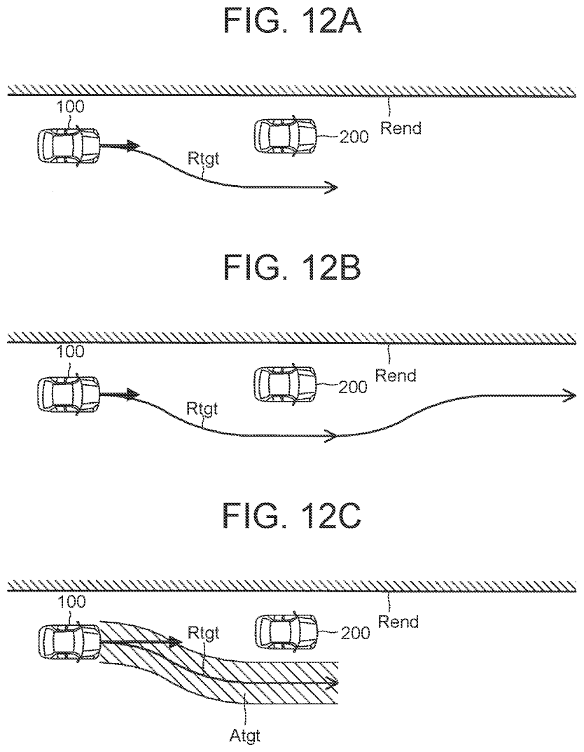

On the other hand, in the case where the left and right marking lines LM have not been recognized and therefore the range of the own lane LN cannot be specified, as shown in FIG. 12A, the vehicle collision-avoidance assist device 10 sets, as the target avoidance path Rtgt, a path along which the host vehicle 100 can avoid and pass by the object 200, regardless of whether the host vehicle 100 travels inside its own lane LN. While the target avoidance path Rtgt shown in FIG. 12A is a path along which the host vehicle 100 travels so as to pass on the right side of the object 200, when there is a space for the host vehicle 100 to travel through on the left side of the object 200, a target avoidance path Rtgt that passes on the left side of the object 200 may be set.

The vehicle collision-avoidance assist device 10 may be configured such that, in the case where the left and right marking lines LM have not been recognized, the device sets the target avoidance path Rtgt as shown in FIG. 12B. The target avoidance path Rtgt shown in FIG. 12B is a path along which the host vehicle 100 travels so as to pass on the right side of the object 200 and then returns to the front side of the object 200.

To avoid collision between the host vehicle 100 and the object 200 by forcibly steering the host vehicle 100 so as to travel along the target avoidance path Rtgt, it is preferable that, when setting the target avoidance path Rtgt, the vehicle collision-avoidance assist device 10 set the target avoidance path Rtgt according to the relative speed dV of the host vehicle 100 relative to the object 200. Therefore, the vehicle collision-avoidance assist device 10 may be configured to set the target avoidance path Rtgt by taking into account the relative speed dV of the host vehicle 100 relative to the object 200.

The vehicle collision-avoidance assist device 10 prohibits execution of the avoidance steering when there is no space on each side of the object 200 that allows the host vehicle 100 to travel safely while avoiding the object 200, and therefore the target avoidance path Rtgt cannot be set. In this case, therefore, the avoidance steering is not executed even when an avoidance steering starting condition, to be described later, is met.

Further, the vehicle collision-avoidance assist device 10 may be configured to give a warning to let the driver of the host vehicle 100 know that the host vehicle 100 is likely to collide with the object 200, before the avoidance path setting condition is met or at the time this condition is met, and to start the avoidance steering when, despite the warning, the driver does not perform operation for avoiding collision between the host vehicle 100 and the object 200 (operation of the accelerator pedal 31, operation of the brake pedal 32, and operation of the steering wheel 33) and consequently the avoidance steering starting condition is met.

In the case where the left and right marking lines LM have not been recognized, after setting the target avoidance path Rtgt, the vehicle collision-avoidance assist device 10 acquires, as an avoidance travel region Atgt, a region that is centered at the set target avoidance path Rtgt and has the same width as the width of the host vehicle 100 as shown in FIG. 12C by inference. The avoidance travel region Atgt corresponds to a travel region that the host vehicle 100 occupies when the host vehicle 100 is assumed to travel along the target avoidance path Rtgt.

After acquiring the avoidance travel region Atgt, the vehicle collision-avoidance assist device 10 determines whether the avoidance travel region Atgt overlaps with the oncoming vehicle travel region A202. In other words, the vehicle collision-avoidance assist device 10 determines whether the avoidance travel region Atgt is present in the oncoming vehicle travel region A202.

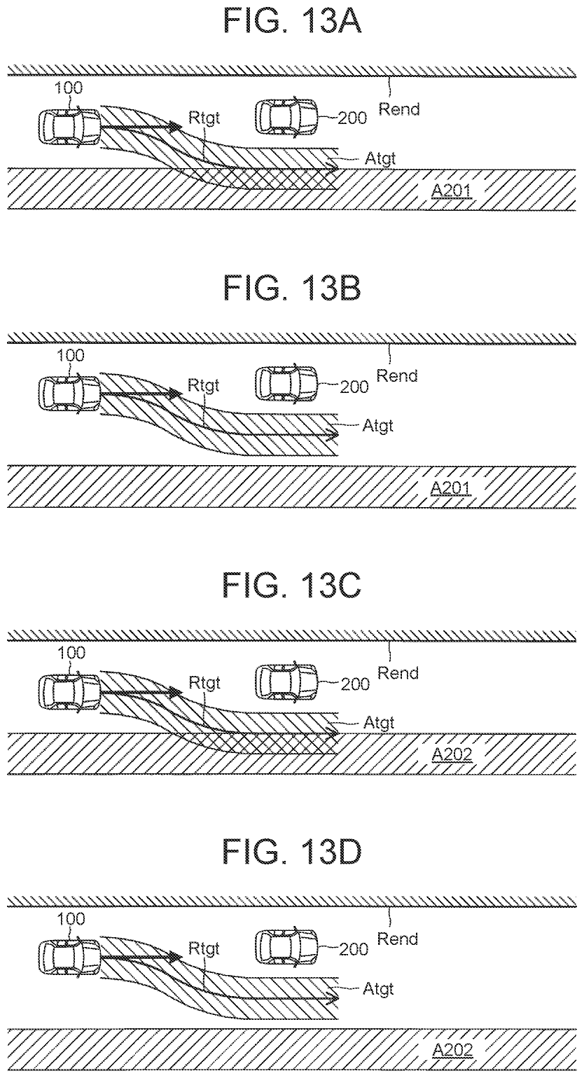

When the vehicle collision-avoidance assist device 10 determines that the avoidance travel region Atgt overlaps with the oncoming vehicle travel region A202 as shown in FIG. 13A, it prohibits execution of the avoidance steering. In this case, the avoidance steering is not executed even when the avoidance steering starting condition, to be described later, is met.

On the other hand, when the vehicle collision-avoidance assist device 10 determines that the avoidance travel region Atgt does not overlap with the oncoming vehicle travel region A202 as shown in FIG. 13B, it determines whether the avoidance travel region Atgt overlaps with the vehicle-traveling-alongside travel region A201. In other words, the vehicle collision-avoidance assist device 10 determines whether the avoidance travel region Atgt is present in the vehicle-traveling-alongside travel region A201.

Also when the oncoming vehicle travel region A202 has not been acquired at the point when the avoidance travel region Atgt is acquired, the vehicle collision-avoidance assist device 10 determines whether the avoidance travel region Atgt overlaps with the vehicle-traveling-alongside travel region A201.

When the vehicle collision-avoidance assist device 10 determines that the avoidance travel region Atgt overlaps with the vehicle-traveling-alongside travel region A201 as shown in FIG. 13C, it permits execution of the avoidance steering. In this case, the avoidance steering is started when the avoidance steering starting condition, to be described later, is met.

On the other hand, when the vehicle collision-avoidance assist device 10 determines that the avoidance travel region Atgt does not overlap with the vehicle-traveling-alongside travel region A201 as shown in FIG. 13D, the vehicle collision-avoidance assist device 10 prohibits execution of the avoidance steering. In this case, the avoidance steering is not executed even when the avoidance steering starting condition, to be described later, is met.

When neither the oncoming vehicle travel region A202 nor the vehicle-traveling-alongside travel region A201 has been acquired at the point when the avoidance travel region Atgt is acquired, the vehicle collision-avoidance assist device 10 prohibits execution of the avoidance steering. In this case, the avoidance steering is not executed even when the avoidance steering starting condition, to be described later, is met.

The vehicle collision-avoidance assist device 10 may be configured to permit execution of the avoidance steering when it determines that the avoidance travel region Atgt overlaps with neither the oncoming vehicle travel region A202 nor the vehicle-traveling-alongside travel region A201.

When the relative speed dV is constant, the expected reaching time TTC becomes shorter as the host vehicle 100 comes closer to the object 200. When the host vehicle 100 comes close to the object 200 and the expected reaching time TTC decreases to the predetermined time (predetermined expected reaching time TTCth), the vehicle collision-avoidance assist device 10 determines that the avoidance steering starting condition is met. Specifically, the vehicle collision-avoidance assist device 10 acquires the expected reaching time TTC as an index value showing the likelihood of the host vehicle 100 colliding with the object 200, and when this index value becomes equal to or larger than a predetermined index value, determines that the avoidance steering starting condition is met. In this case, therefore, the index value showing the likelihood of the host vehicle 100 colliding with the object 200 becomes larger as the expected reaching time TTC becomes shorter.

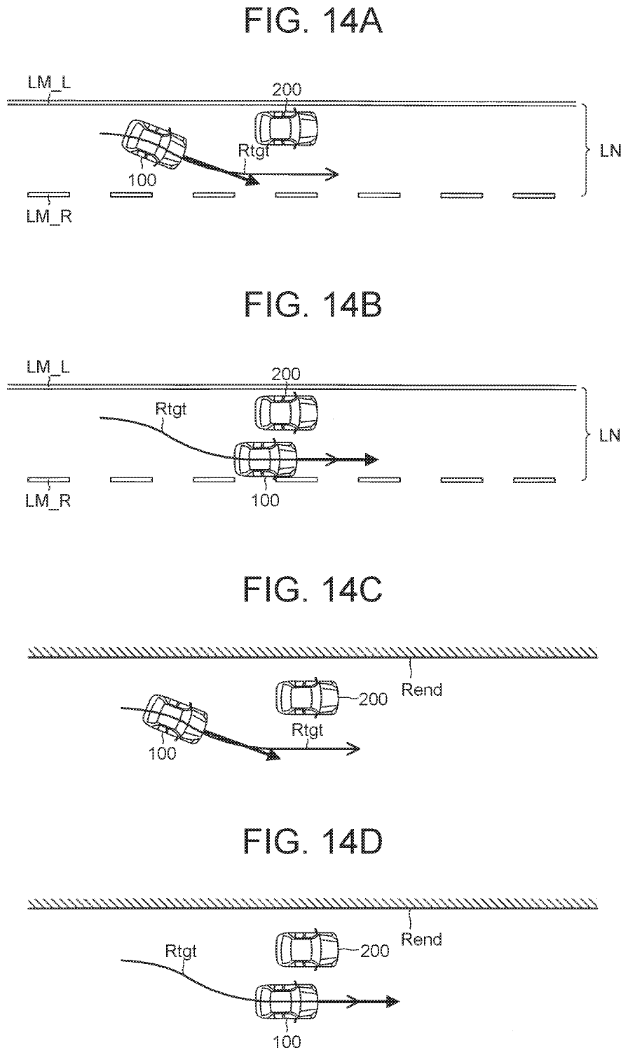

When the avoidance steering starting condition is met in a state where the left and right marking lines LM have been recognized and the target avoidance path Rtgt has been set, the vehicle collision-avoidance assist device 10 starts the avoidance steering. In this case, the vehicle collision-avoidance assist device 10 executes steering (avoidance steering) of the host vehicle 100 that involves controlling the assisting steering torque TQas such that the host vehicle 100 travels along the target avoidance path Rtgt. Thus, the host vehicle 100 is steered so as to travel along the target avoidance path Rtgt as shown in FIG. 14A, so that collision with the object 200 can be avoided as shown in FIG. 14B.

In addition to the avoidance steering, the vehicle collision-avoidance assist device 10 may decelerate the host vehicle 100 by reducing the drive power provided to the host vehicle 100 or limiting this drive power to or below a certain value, or by providing braking power to the host vehicle 100.

Also when the avoidance steering starting condition is met in a state where the left and right marking lines LM have not been recognized but execution of the avoidance steering is permitted and the target avoidance path Rtgt has been set, the vehicle collision-avoidance assist device 10 starts the avoidance steering. Also in this case, the vehicle collision-avoidance assist device 10 executes steering (avoidance steering) of the host vehicle 100 that involves controlling the assisting steering torque TQas such that the host vehicle 100 travels along the target avoidance path Rtgt. Thus, the host vehicle 100 is steered so as to travel along the target avoidance path Rtgt as shown in FIG. 14C, so that collision with the object 200 can be avoided as shown in FIG. 14D.

As the condition for prohibiting execution of the avoidance steering (avoidance steering prohibition condition), the following Condition C1 to Condition C20 can also be adopted as appropriate.

Condition C1 is a condition that the avoidance steering cannot be realized for reasons such as that a device for realizing the avoidance steering (e.g., the steering device 23) has an abnormality.

Condition C2 is a condition that, in a case where the vehicle collision-avoidance assist device 10 is configured to be able to execute automatic braking control (Pre-crash Safety System (PCS)), the automatic braking control cannot be realized for reasons such as that a device for realizing the automatic braking control (e.g., the braking device 22) has an abnormality. The automatic braking control refers to control that, when it becomes highly likely that the host vehicle 100 collides with an object present ahead of the host vehicle 100, forcibly brakes the host vehicle 100 to stop the host vehicle 100 before colliding with that object.

Condition C3 is a condition that, in a case where the vehicle collision-avoidance assist device 10 is configured to be able to execute sideslip prevention control (Vehicle Stability Control (VSC)), the sideslip prevention control cannot be realized for reasons such as that a device for realizing the sideslip prevention control (e.g., the braking device 22) has an abnormality. The sideslip prevention control refers to control that, when the travel behavior of the host vehicle 100 becomes unstable due to, for example, steering of the host vehicle 100, stabilizes the travel behavior of the host vehicle 100 by adjusting the drive power PD provided to the drive wheels of the host vehicle 100 or individually adjusting the braking power PB provided to the respective wheels of the host vehicle 100.

Condition C4 is a condition that, in the case where the vehicle collision-avoidance assist device 10 is configured to be able to execute the automatic braking control (PCS), the host vehicle 100 can be stopped by the automatic braking control before colliding with the object 200.

Condition C5 is a condition that, in a case where the vehicle collision-avoidance assist device 10 is configured to be able to execute the automatic braking control (PCS) and the automatic braking control has been executed first, the time that has elapsed since the end of the automatic braking control is within a predetermined time.

Condition C6 is a condition that, in a case where the steering avoidance control has been executed first, the time that has elapsed since the end of the steering avoidance control is within a predetermined time.

Condition C7 is a condition that a turn signal of the host vehicle 100 is on (flashing).

Condition C8 is a condition that, in a case where the object 200 is a vehicle traveling ahead and the target avoidance path Rtgt is a route that passes on the left side of the vehicle traveling ahead, the left turn signal of the vehicle traveling ahead is on (flashing). The vehicle collision-avoidance assist device 10 can determine whether the left turn signal of the vehicle traveling ahead is on (flashing) based on the surroundings information I_S. The vehicle traveling ahead is a vehicle that is traveling in the own lane LN on the front side of the host vehicle 100, in the same direction as the advancing direction of the host vehicle 100.

Condition C9 is a condition that, in a case where the object 200 is a vehicle traveling ahead and the target avoidance path Rtgt is a route that passes on the right side of the vehicle traveling ahead, the right turn signal of the vehicle traveling ahead is on (flashing). The vehicle collision-avoidance assist device 10 can determine whether the right turn signal of the vehicle traveling ahead is on (flashing) based on the surroundings information I_S.

Condition C10 is a condition that the accelerator pedal operation amount AP is equal to or larger than a predetermined accelerator pedal operation amount APth.

Condition C11 is a condition that the brake pedal operation amount BP is equal to or larger than a predetermined brake pedal operation amount BPth.

Condition C12 is a condition that the vehicle speed V of the host vehicle 100 is not a vehicle speed within a predetermined range Rv.

Condition C13 is a condition that the relative speed dV of the object 200 relative to the host vehicle 100 is not a speed within a predetermined range Rdv.

Condition C14 is a condition that the lateral acceleration Gy is equal to or greater than a predetermined lateral acceleration Gy_th.

Condition C15 is a condition that the longitudinal acceleration Gx has a positive value and the absolute value thereof is equal to or larger than a predetermined value Gx_th.

Condition C16 is a condition that the longitudinal acceleration Gx has a negative value and the absolute value thereof is equal to or larger than the predetermined value Gx_th.

Condition C17 is a condition that the host vehicle 100 is traveling on a curved road. The vehicle collision-avoidance assist device 10 can determine whether the host vehicle 100 is traveling on a curved road based on the surroundings information I_S.

Condition C18 is a condition that the target avoidance path Rtgt crosses a center line of the object 200 in the front-rear direction. The vehicle collision-avoidance assist device 10 can determine whether the target avoidance path Rtgt crosses the center line of the object 200 in the front-rear direction based on the surroundings information I_S.

Condition C19 is a condition that the object 200 is moving so as to cross the target avoidance path Rtgt. The vehicle collision-avoidance assist device 10 can determine whether the object 200 is moving so as to cross the target avoidance path Rtgt based on the surroundings information I_S.

Condition C20 is a condition that the target avoidance path Rtgt has been set but that the target avoidance path Rtgt is a route along which the host vehicle 100 is expected to be unable to travel.

End of Steering Avoidance Control

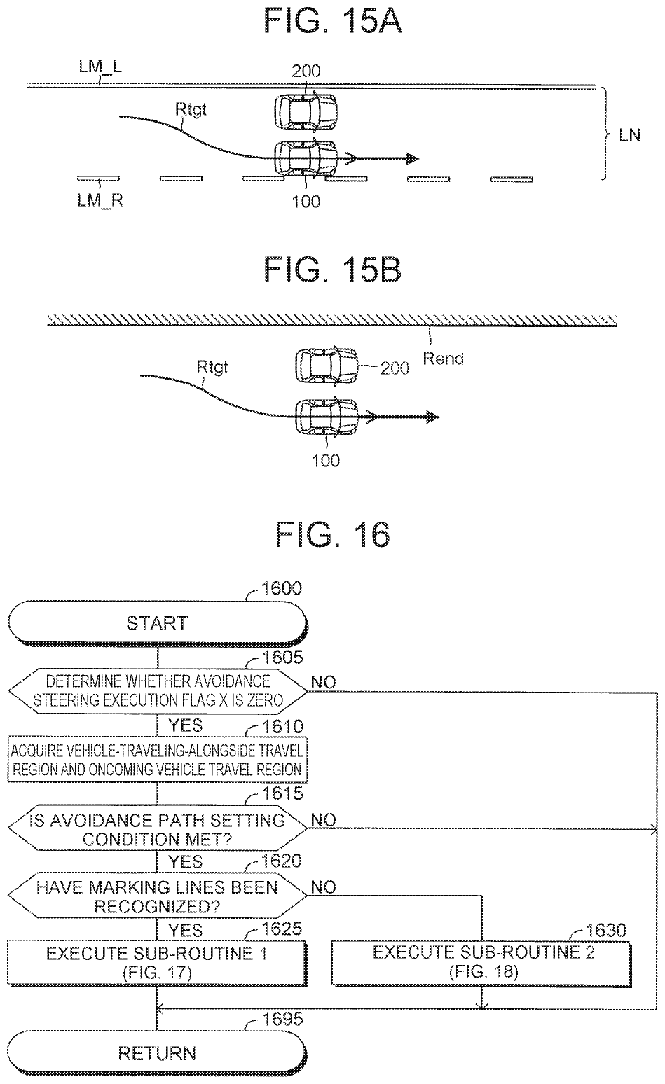

When a condition for ending the avoidance steering (avoidance steering ending condition) is met, the vehicle collision-avoidance assist device 10 ends the avoidance steering. For example, in the case where the left and right marking lines LM have been recognized, even when the avoidance steering is started and then the avoidance steering is ended while the host vehicle 100 is passing by the object 200 as shown in FIG. 15A, the host vehicle 100 is unlikely to collide with the object 200. Similarly, also in the case where the left and right marking lines LM have not been recognized, even when the avoidance steering is started and then the avoidance steering is ended while the host vehicle 100 is passing by the object 200 as shown in FIG. 15B, the host vehicle 100 is unlikely to collide with the object 200. Therefore, as the avoidance steering ending condition, for example, a condition that after the avoidance steering is started, the host vehicle 100 is passing by the object 200 is set.

The vehicle collision-avoidance assist device 10 can determine that the host vehicle 100 is passing by the object 200 based on the surroundings information I_S. Further, when the host vehicle 100 is passing by the object 200, the absolute value of the yaw angle YA decreases. Therefore, the vehicle collision-avoidance assist device 10 may be configured to determine that the host vehicle 100 is passing by the object 200, when, after the avoidance steering is started, the absolute value of the yaw angle YA becomes equal to or smaller than a predetermined yaw angle YAth. In addition, when the host vehicle 100 is passing by the object 200, the absolute value of the yaw rate of the host vehicle 100 decreases. Therefore, the vehicle collision-avoidance assist device 10 may be configured to determine that the host vehicle 100 is passing by the object 200, when the absolute value of the yaw rate of the host vehicle 100 becomes equal to or smaller than a predetermined yaw rate.

In the case where the vehicle collision-avoidance assist device 10 is configured to execute the avoidance steering while braking the host vehicle 100 so as to stop the host vehicle 100, the vehicle collision-avoidance assist device 10 may be configured to determine that the avoidance steering ending condition is met when the host vehicle 100 stops.

The vehicle collision-avoidance assist device 10 may be configured to suspend the avoidance steering when the driver-input torque TQdr becomes equal to or higher than a relatively high predetermined torque TQth during execution of the steering avoidance control.

Effects

When the lane next to the own lane LN (adjacent lane) is a lane traveling in the same direction, compared with when the adjacent lane is a lane traveling in the opposite direction, it is relatively safe for the host vehicle 100 to enter the adjacent lane in order to avoid collision with the object 200. Therefore, when the avoidance travel region Atgt overlaps with the vehicle-traveling-alongside travel region A201, since the adjacent lane that the host vehicle 100 is going to enter to avoid collision with the object 200 is a lane traveling in the same travel direction, it is relatively safe for the host vehicle 100 to enter the adjacent lane. The vehicle collision-avoidance assist device 10 does not execute the avoidance steering when the avoidance travel region Atgt overlaps with the oncoming vehicle travel region A202, but executes the avoidance steering when the avoidance travel region Atgt overlaps with the vehicle-traveling-alongside travel region A201. Accordingly, this device executes the avoidance steering even in the case where it cannot make the host vehicle 100 travel inside its own lane LN when avoiding collision between the host vehicle 100 and the object 200 by the avoidance steering. Thus, collision between the host vehicle 100 and the object 200 can be safely avoided even when the own lane LN cannot be specified.

Specific Operation of Vehicle Collision-Avoidance Assist Device

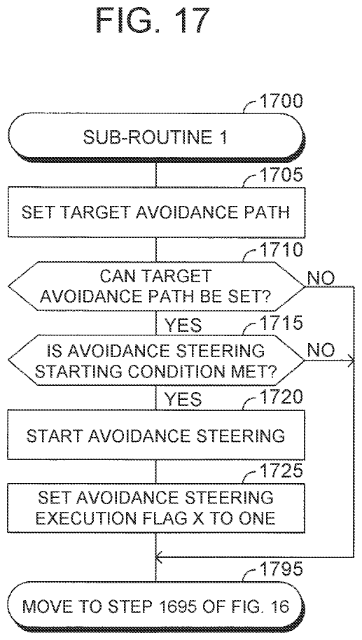

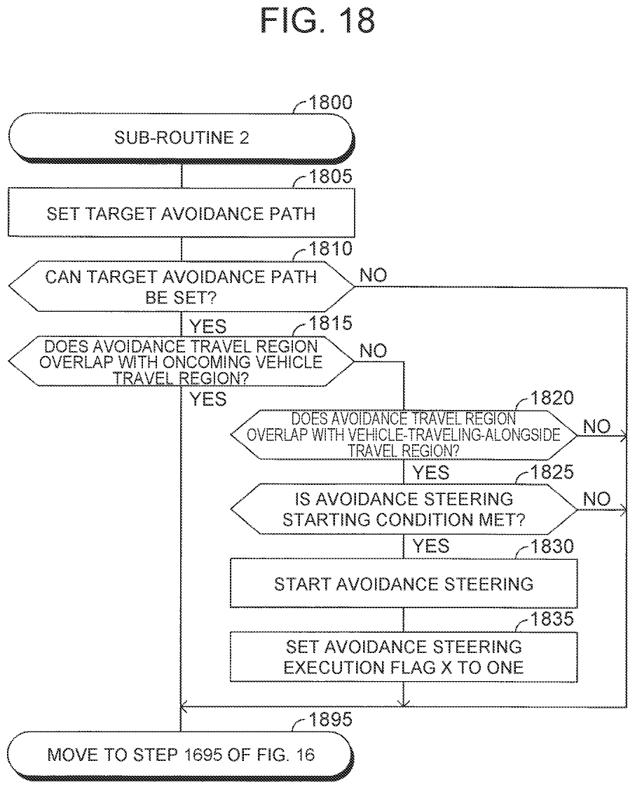

Next, the specific operation of the vehicle collision-avoidance assist device 10 will be described. The CPU of the ECU 90 of the vehicle collision-avoidance assist device 10 is configured to execute the routine shown in FIG. 16 every time a predetermined time has elapsed. Therefore, when a predetermined timing comes, the CPU starts the process from step 1600 of FIG. 16 and moves the process to step 1605, where it determines whether the value of an avoidance steering execution flag X is zero. The value of the avoidance steering execution flag X is set to one when the avoidance steering is started and set to zero when the avoidance steering is ended.

When the CPU determines “Yes” in step 1605, the CPU moves the process to step 1610 and acquires the vehicle-traveling-alongside travel region A201 and the oncoming vehicle travel region A202. Then, the CPU moves the process to step 1615 and determines whether the avoidance path setting condition is met.

When the CPU determines “Yes” in step 1615, the CPU moves the process to step 1620 and determines whether the left and right marking lines LM have been recognized.

When the CPU determines “Yes” in step 1620, the CPU moves the process to step 1625 and executes the routine shown in FIG. 17. Therefore, when the CPU moves the process to step 1625, the CPU starts the process from step 1700 of FIG. 17 and moves the process to step 1705, where it sets the target avoidance path Rtgt. Then, the CPU moves the process to step 1710 and determines whether the target avoidance path Rtgt has been set.

When the CPU determines “Yes” in step 1710, the CPU moves the process to step 1715 and determines whether the avoidance steering starting condition is met.

When the CPU determines “Yes” in step 1715, the CPU moves the process to step 1720 and starts the avoidance steering. Then, the CPU moves the process to step 1725 and sets the value of the avoidance steering execution flag X to one. Then, the CPU moves the process to step 1695 of FIG. 16 via step 1795 and temporarily ends the current routine.

On the other hand, when the CPU determines “No” in step 1710 or step 1715, the CPU moves the process to step 1695 of FIG. 16 via step 1795 and temporarily ends the current routine. In this case, the avoidance steering is not executed.

When the CPU determines “No” in step 1620 of FIG. 16, the CPU moves the process to step 1630 and executes the routine shown in FIG. 18. Therefore, when the CPU moves the process to step 1630, the CPU starts the process from step 1800 of FIG. 18 and moves the process to step 1805, where it sets the target avoidance path Rtgt. Then, the CPU moves the process to step 1810 and determines whether the target avoidance path Rtgt has been set.

When the CPU determines “Yes” in step 1810, it moves the process to step 1815 and determines whether the avoidance travel region Atgt overlaps with the oncoming vehicle travel region A202.

When the CPU determines “Yes” in step 1815, the CPU moves the process to step 1695 of FIG. 16 via step 1895 and temporarily ends the current routine.

On the other hand, when the CPU determines “No” in step 1815, it moves the process to step 1820 and determines whether the avoidance travel region Atgt overlaps with the vehicle-traveling-alongside travel region A201.

When the CPU determines “Yes” in step 1820, the CPU moves the process to step 1825 and determines whether the avoidance steering starting condition is met.

When the CPU determines “Yes” in step 1825, the CPU moves the process to step 1830 and starts the avoidance steering. Then, the CPU moves the process to step 1835 and sets the value of the avoidance steering execution flag X to one. Then, the CPU moves the process to step 1695 of FIG. 16 via step 1895 and temporarily ends the current routine.

When the CPU determines “No” in step 1820 or step 1825, the CPU moves the process to step 1695 of FIG. 16 via step 1895 and temporarily ends the current routine.

Also when the CPU determines “No” in step 1810, the CPU moves the process to step 1695 of FIG. 16 via step 1895 and temporarily ends the current routine.

Further, the CPU executes the routine shown in FIG. 19 every time a predetermined calculation time has elapsed. Therefore, when a predetermined timing comes, the CPU starts the process from step 1900 of FIG. 19 and moves the process to step 1905, where it determines whether the value of the avoidance steering execution flag X is one.

When the CPU determines “Yes” in step 1905, the CPU moves the process to step 1910 and determines whether the avoidance steering ending condition is met.

When the CPU determines “Yes” in step 1910, the CPU moves the process to step 1915 and ends the avoidance steering. Then, the CPU moves the process to step 1920 and sets the value of the avoidance steering execution flag X to zero. Then, the CPU moves the process to step 1995 and temporarily ends the current routine.

On the other hand, when the CPU determines “No” in step 1905 or step 1910, the CPU moves the process directly to step 1915 and temporarily ends the current routine.

The above is the specific operation of the vehicle collision-avoidance assist device 10.

The applicable embodiment is not limited to the above embodiment, and various modified examples can be adopted within the scope of the present disclosure.

### Modified Example

For example, the vehicle collision-avoidance assist device 10 may be configured to set the target avoidance path Rtgt without determining whether the left and right marking lines LM have been recognized from the surroundings information I_S at the point when the avoidance path setting condition is met, and to permit or prohibit the avoidance steering according to whether the avoidance travel region Atgt acquired based on that target avoidance path Rtgt overlaps with the oncoming vehicle travel region A202 or the vehicle-traveling-alongside travel region A201.

When the avoidance path setting condition is met, the vehicle collision-avoidance assist device 10 according to this modified example of the embodiment of the present disclosure sets the target avoidance path Rtgt, acquires the avoidance travel region Atgt based on the target avoidance path Rtgt, and determines whether the avoidance travel region Atgt overlaps with the oncoming vehicle travel region A202.

When the avoidance travel region Atgt overlaps with the oncoming vehicle travel region A202, the vehicle collision-avoidance assist device 10 prohibits execution of the avoidance steering. In this case, therefore, the avoidance steering is not executed even when the avoidance steering starting condition is met.

On the other hand, when the avoidance travel region Atgt does not overlap with the oncoming vehicle travel region A202, the vehicle collision-avoidance assist device 10 determines whether the avoidance travel region Atgt overlaps with the vehicle-traveling-alongside travel region A201.

When the avoidance travel region Atgt overlaps with the vehicle-traveling-alongside travel region A201, the vehicle collision-avoidance assist device 10 permits execution of the avoidance steering. In this case, therefore, the avoidance steering is executed when the avoidance steering starting condition is met.

On the other hand, when the avoidance travel region Atgt does not overlap with the vehicle-traveling-alongside travel region A201, the vehicle collision-avoidance assist device 10 determines whether the avoidance travel region Atgt is located inside the own lane LN.

When the avoidance travel region Atgt is located inside the own lane LN, the vehicle collision-avoidance assist device 10 permits execution of the avoidance steering. In this case, therefore, the avoidance steering is executed when the avoidance steering starting condition is met.

When the avoidance travel region Atgt is not located inside the own lane LN, the vehicle collision-avoidance assist device 10 prohibits execution of the avoidance steering. In this case, therefore, the avoidance steering is not executed even when the avoidance steering starting condition is met.

When the left and right marking lines LM have not been recognized and therefore the range of the own lane LN has not been specified, the vehicle collision-avoidance assist device 10 prohibits execution of the avoidance steering.

Effects

Like the vehicle collision-avoidance assist device 10 according to the embodiment of the present disclosure, the vehicle collision-avoidance assist device 10 according to the modified example does not execute the avoidance steering when the avoidance travel region Atgt overlaps with the oncoming vehicle travel region A202, but executes the avoidance steering when the avoidance travel region Atgt overlaps with the vehicle-traveling-alongside travel region A201. Accordingly, this device executes the avoidance steering for avoiding collision between the host vehicle 100 and the object 200 even in the case where it cannot make the host vehicle 100 travel inside its own lane LN when avoiding collision between the host vehicle 100 and the object 200 by the avoidance steering. Thus, collision between the host vehicle 100 and the object 200 can be safely avoided even when the own lane LN cannot be specified.

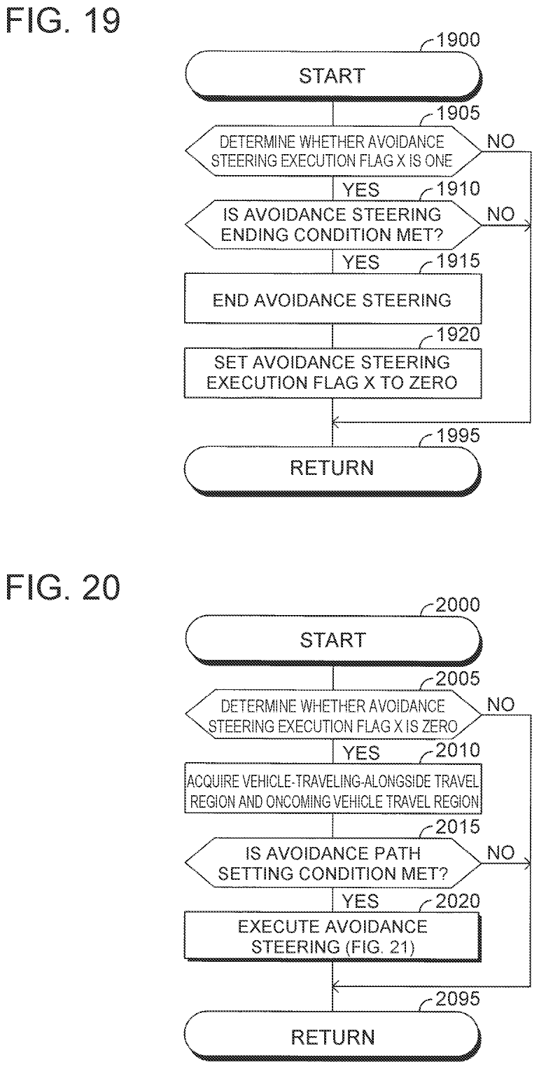

Next, the specific operation of the vehicle collision-avoidance assist device 10 according to the modified example of the embodiment of the present disclosure will be described. The CPU of the ECU 90 of this vehicle collision-avoidance assist device 10 executes the routine shown in FIG. 20 every time a predetermined time has elapsed. Therefore, when a predetermined timing comes, the CPU starts the process from step 2000 of FIG. 20 and moves the process to step 2005, where it determines whether the value of the avoidance steering execution flag X is zero.

When the CPU determines “Yes” in step 2005, the CPU moves the process to step 2010 and acquires the vehicle-traveling-alongside travel region A201 or the oncoming vehicle travel region A202. Then, the CPU moves the process to step 2015 and determines whether the avoidance path setting condition is met.

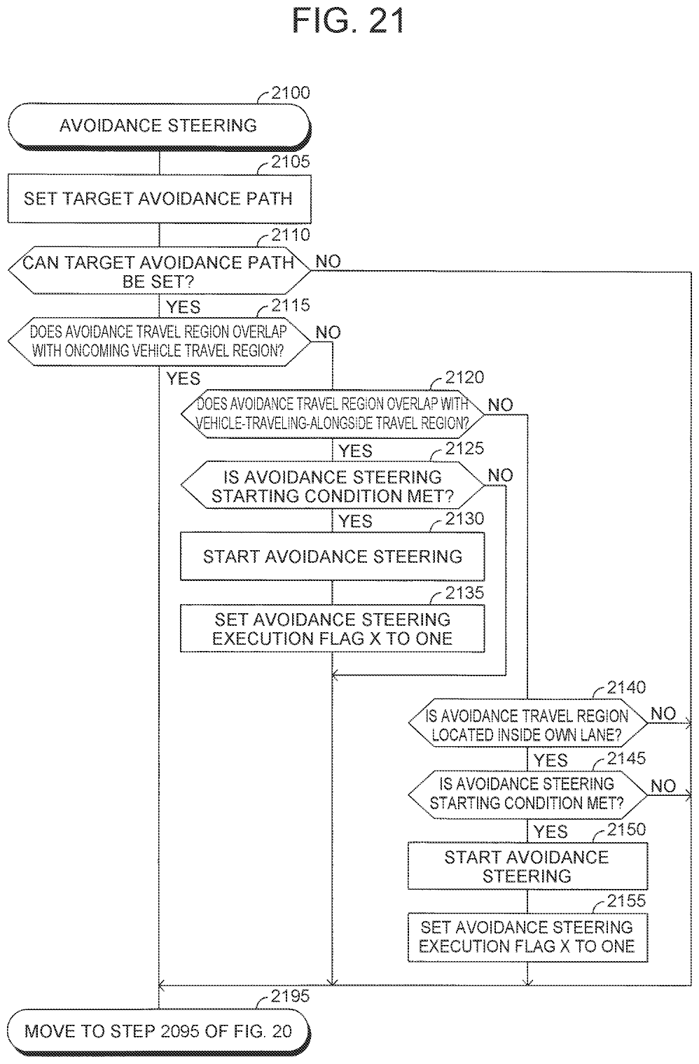

When the CPU determines “Yes” in step 2015, the CPU moves the process to step 2020 and executes the routine shown in FIG. 21. Therefore, when the CPU moves the process to step 2020, the CPU starts the process from step 2100 of FIG. 21 and moves the process to step 2105, where it sets the target avoidance path Rtgt. Then, the CPU moves the process to step 2110 and determines whether the target avoidance path Rtgt has been set.

When the CPU determines “Yes” in step 2110, it moves the process to step 2115 and determines whether the avoidance travel region Atgt overlaps with the oncoming vehicle travel region A202.

When the CPU determines “Yes” in step 2115, the CPU moves the process to step 2095 via step 2195 and temporarily ends the current routine. In this case, the avoidance steering is not executed.

On the other hand, when the CPU determines “No” in step 2115, the CPU moves the process to step 2120 and determines whether the avoidance travel region Atgt overlaps with the vehicle-traveling-alongside travel region A201.

When the CPU determines “Yes” in step 2120, the CPU moves the process to step 2125 and determines whether the avoidance steering starting condition is met.

When the CPU determines “Yes” in step 2125, the CPU moves the process to step 2130 and starts the avoidance steering. Then, the CPU moves the process to step 2135 and sets the value of the avoidance steering execution flag X to one. Then, the CPU moves the process to step 2095 via step 2195 and temporarily ends the current routine.

On the other hand, when the CPU determines “No” in step 2125, the CPU moves the process to step 2095 via step 2195 and temporarily ends the current routine.

When the CPU determines “No” in step 2120, the CPU moves the process to step 2140 and determines whether the avoidance travel region Atgt is located inside the own lane LN.

When the CPU determines “Yes” in step 2140, the CPU moves the process to step 2145 and determines whether the avoidance steering starting condition is met.

When the CPU determines “Yes” in step 2145, the CPU moves the process to step 2150 and starts the avoidance steering. Then, the CPU moves the process to step 2155 and sets the value of the avoidance steering execution flag X to one. Then, the CPU moves the process to step 2095 via step 2195 and temporarily ends the current routine.

On the other hand, when the CPU determines “No” in step 2110 or step 2140 or step 2145, the CPU moves the process to step 2095 via step 2195 and temporarily ends the current routine.

The above is the specific operation of the vehicle collision-avoidance assist device 10 according to the modified example of the embodiment of the present disclosure.

What is claimed is:

1. A vehicle collision-avoidance assist device configured such that, when a host vehicle is likely to collide with an object present ahead of the host vehicle, the device sets an avoidance path by which collision between the host vehicle and the object is avoidable as a target avoidance path upon an avoidance path setting condition being met, and executes avoidance steering of forcibly steering the host vehicle so as to travel along the target avoidance path upon an avoidance steering starting condition for starting the avoidance steering being met, wherein the vehicle collision-avoidance assist device is configured such that:
when another vehicle that is traveling next to the host vehicle is a vehicle traveling alongside, the device stores a travel region that the vehicle traveling alongside occupies while traveling as a vehicle-traveling-alongside travel region;
when the other vehicle is an oncoming vehicle, the device stores a travel region that the oncoming vehicle occupies while traveling as an oncoming vehicle travel region;
the device acquires a travel region that the host vehicle occupies when the host vehicle is assumed to travel along the target avoidance path as an avoidance travel region;
when the avoidance travel region overlaps with the oncoming vehicle travel region, the device does not execute the avoidance steering even when the avoidance steering starting condition is met; and
when the avoidance travel region overlaps with the vehicle-traveling-alongside travel region, the device executes the avoidance steering upon the avoidance steering starting condition being met.

2. The vehicle collision-avoidance assist device according to claim 1, wherein the vehicle collision-avoidance assist device is configured to acquire the avoidance travel region when a lane in which the host vehicle is traveling has not been specified at a point when the avoidance path setting condition is met.

3. The vehicle collision-avoidance assist device according to claim 2, wherein the vehicle collision-avoidance assist device is configured such that, when a lane in which the host vehicle is traveling has been specified at a point when the avoidance path setting condition is met, the device sets, as the target avoidance path, an avoidance path by which collision between the host vehicle and the object is avoidable inside the lane in which the host vehicle is traveling.

4. The vehicle collision-avoidance assist device according to claim 1, comprising a surroundings information acquisition device that acquires information on surroundings of the host vehicle, wherein the vehicle collision-avoidance assist device is configured such that:
when the vehicle traveling alongside is detected based on the information on the surroundings, the vehicle collision-avoidance assist device stores relative positions of the vehicle traveling alongside relative to the host vehicle at different times of day, and, based on distances that the host vehicle has traveled since the respective relative positions have been stored, converts these relative positions into positions on a travel road at which the vehicle traveling alongside was located when the respective relative positions were stored, and then acquires a travel track of the vehicle traveling alongside from these converted positions and acquires the vehicle-traveling-alongside travel region from the acquired travel track; and
when the oncoming vehicle is detected based on the information on the surroundings, the vehicle collision-avoidance assist device stores relative positions of the oncoming vehicle relative to the host vehicle at different times of day, and, based on distances that the host vehicle has traveled since the respective relative positions have been stored, converts these relative positions into positions on a travel road at which the oncoming vehicle was located when the respective relative positions were stored, and then acquires a travel track of the oncoming vehicle from these converted positions and acquires the oncoming vehicle travel region from the acquired travel track.

5. The vehicle collision-avoidance assist device according to claim 1, wherein the avoidance path setting condition is met when a distance between the host vehicle and the object becomes equal to or shorter than a predetermined distance.

6. The vehicle collision-avoidance assist device according to claim 1, wherein the avoidance steering starting condition is met when a time expected to be taken for the host vehicle to reach the object becomes equal to or shorter than a predetermined time.

7. The vehicle collision-avoidance assist device according to claim 1, wherein the target avoidance path is set by taking into account a relative speed of the host vehicle relative to the object at a point when the avoidance path setting condition is met.
